(19) United States
(12) Patent Application Publication
(10) Pub. No.: US 2010/0003765 A1
(43) Pub. Date: Jan. 7, 2010

(54) METHODS AND SYSTEMS FOR MITIGATING OXYGEN ENHANCED DAMAGE IN REAL-TIME ANALYTICAL OPERATIONS

(75) Inventors: John Dixon, Moss Beach, CA (US); Mark Trulson, San Jose, CA (US)

Correspondence Address: PACIFIC BIOSCIENCES OF CALIFORNIA, INC., 1505 ADAMS DR., MENLO PARK, CA, 94025, US

(73) Assignee: Pacific Biosciences of California, Inc., Menlo Park, CA (US)

(21) Appl. No.: 12/465,380

(22) Filed: May 13, 2009

Related U.S. Application Data
(60) Provisional application No. 61/127,435, filed on May 13, 2008.

(51) Int. Cl. G01N 21/64

(52) U.S. Cl. 436/172; 422/82.08

(57) ABSTRACT

Methods and systems for performing analytical reactions under reduced or non-oxygen conditions, where such reactions are potentially subject to damaging effects of oxygen, including particularly fluorescent based detection methods where fluorescent species may be prone to generation of reactive oxygen species.

### CROSS-REFERENCE TO RELATED APPLICATIONS

This application claims the benefit of U.S. Provisional Application No. 61/127,435, filed May 13, 2008, the full disclosure of which is incorporated herein by reference in its entirety for all purposes.

### STATEMENT REGARDING FEDERALLY SPONSORED RESEARCH

Not Applicable.

### BACKGROUND OF THE INVENTION

Real-time analytical systems have been developed for a number of different biochemical analyses. For example, the availability of fluorogenic reagents, e.g., that emit characteristic fluorescent signals upon interaction in a reaction of interest, provides the ability to monitor the reaction of interest as it is occurring. Examples of such real time analyses include the monitoring of polymerase chain reactions through the detection of the fluorescent cleavage products of probes hybridized to the template sequence to be amplified (See, e.g., Taqman® products RT PCR systems available from Applied Biosystems (Foster City, Calif.). Other real time reagents include, e.g., molecular beacons, that provide fluorescent indications of nucleic acid hybridization events. Another useful real-time analytical process involves the real-time monitoring of template dependent nucleic acid synthesis, which is used in the determination of, e.g., the underlying nucleic acid sequence of the template (See, e.g., U.S. Pat. Nos. 7,056,661, 7,052,847, 7,033,764 and 7,056,676, the full disclosures of which are incorporated herein by reference in their entirety for all purposes).

Performance of real-time optical analysis typically requires constant illumination of the reaction mixtures with an appropriate level of excitation illumination, i.e., sufficient to excite the fluorescent reactants and/or products for detection. However, in a number of instances, constant illumination of biological compounds, such as proteins, enzymes, or the like, in the presence of fluorescent compounds, can yield effects that are detrimental to those biological compounds. Without being bound to any particular theory of operation, it is believed by the inventors, that at least a portion of such damaging effects result from interactions of the various reaction components with oxygen that is present in the reaction mixture, e.g., through oxygen radicals or the accumulation of reaction intermediates that is mediated by the presence of oxygen.

Accordingly, it is desirable to provide methods and systems for carrying out real-time analysis with reduced levels of oxygen present in the system, and the present invention addresses these and other needs.

### BRIEF SUMMARY OF THE INVENTION

Technologies related to analysis of biological information have advanced rapidly over the past decade. In particular, with the improved ability to characterize genetic sequence information, identify protein structure, elucidate biological pathways, and manipulate any or all of these, has come the need for improved abilities to derive and process this information.

In a first aspect, the invention provides an analytical system, comprising a reaction vessel containing a reaction mixture that comprises at least a first biochemical reactant and a first fluorescent or fluorogenic reactant, an excitation light source configured to direct excitation light at the reaction vessel, and a reagent delivery system fluidically coupled to the reaction vessel, wherein the fluid delivery system is configured to reduce dissolved oxygen present in reagents delivered to the reaction vessel.

In a related aspect, provided is an analytical system, comprising a reaction chamber, a source of inert, non-oxygen gas coupled to the reaction chamber, a reaction vessel disposed within the reaction chamber and containing a reaction mixture that comprises at least a first biochemical reactant and a first fluorescent or fluorogenic reactant, wherein the reaction mixture is capable of generating reactive oxygen species when exposed to excitation light, and a fluorescence detection system configured to direct excitation light at the reaction vessel, and collect fluorescent signals from the reaction vessel.

Also provided are methods of monitoring a biological reaction, comprising providing a reduced oxygen reaction vessel, introducing at least one reagent to the reduced oxygen reaction vessel to provide a biological reaction mixture that produces a fluorescent signal indicative of the biological reaction, wherein the at least one reagent is maintained in a reduced oxygen environment prior to introduction into the reduced oxygen reaction vessel, and monitoring fluorescent signals from the reduced oxygen reaction vessel to monitor the biological reaction.

In still a further aspect, the invention provides a method of monitoring a biological reaction, comprising providing a reduced oxygen reaction vessel, introducing at least one reagent to the reduced oxygen reaction vessel to provide a biological reaction mixture that produces a fluorescent signal indicative of the biological reaction, wherein the at least one reagent is treated with an oxygen removal system prior to introduction into the reduced oxygen reaction vessel, and monitoring fluorescent signals from the reduced oxygen reaction vessel to monitor the biological reaction.

In still another aspect, the invention provides a method of observing a reaction in real-time, comprising providing a reaction mixture that comprises a fluorescent or fluorogenic reactant that produces a signal characteristic of the reaction providing a reduced oxygen environment over the reaction mixture directing excitation light at the reaction mixture during the reaction, and monitoring fluorescent signals characteristic of the reaction, from the reaction mixture, during the reaction.

### BRIEF DESCRIPTION OF THE DRAWINGS

FIG. 1 schematically illustrates an exemplary fluorescent reaction analysis system.

FIG. 2 schematically illustrates a system employing an in-line oxygen removal system for reagents.

FIG. 3 schematically illustrates a reduced oxygen reaction chamber integrated into a fluorescence detection system.

FIG. 4 schematically illustrates a gas purged fluid handling system for use in reduced oxygen applications.

FIG. 5 shows a plot of dissolved oxygen following passage through an oxygen scrubbing cartridge.

### DETAILED DESCRIPTION OF THE INVENTION

The present invention is generally directed to methods and systems that provide reduced oxygen environments for analytical reactions, and particularly for real-time fluorescence based assays, such as nucleic acid sequencing methods that potentially are negatively impacted by the presence and or generation of oxygen and its reactive species.

### I. Real Time Analysis

As alluded to previously, the present invention is particularly useful when applied to real-time analyses of fluorescent or fluorogenic reaction components. In general, such reactions employ reagents that undergo one or more changes in a detectable fluorescent signal as the reaction progresses. Such changes can include increases or decreases in the level or intensity of a fluorescent signal, shifts in the spectral characteristics (excitation or emission spectra), lifetimes, polarization or other optical characteristics of a fluorescent signal, localization of a fluorescent signal to a particular region on a substrate or other solid support (or release therefrom), or a variety of other identifiable characteristics that may be associated with fluorescent signals. Typically, monitoring these changes in fluorescent signals over a given time period requires direction of excitation radiation at the reaction of interest over the same time period, so as to excite the relevant fluorescent component so that it may be monitored.

Real-time analysis is routinely used to observe a variety of enzymatic reactions by observing the change in fluorescent signals over time. Typically, such reactions employ a reactant that, when acted upon by the enzyme or other reaction system of interest, generates a fluorescent product or otherwise yields a change in the fluorescent characteristics of the reaction mixture. One example of a preferred class of real-time analyses is the analysis of single molecule interactions using fluorescent or fluorogenic reaction components. Because single molecules or complexes are being observed, one can observe specific reactions in real-time, without having to qualify observations based upon the aggregation and/or averaging of characteristics observed in bulk reactant populations. However, because individual molecules or molecular complexes are being observed, the reactions are more susceptible to potentially damaging effects of consistent and prolonged illumination. In particular, while bulk reactions can mask some deterioration through the presence of large populations of reagents, damage to a single molecule reaction can impact the entire reaction being observed.

The effects of such deterioration are of particular interest in reactions that are observed over longer periods of time, e.g., up to several minutes. Such reactions include reactions in low reagent concentrations or for slower enzyme systems. Another example of such reactions includes nucleic acid sequencing reactions that are dependent upon the processive activity of nucleic acid polymerases or other enzymes, e.g., exonucleases, in identifying base sequences of nucleic acid molecules.

In one exemplary aspect, a complex of a nucleic acid polymerase, a target nucleic acid sequence, and a primer sequence complementary to a portion of the target, is observed in the presence of four different fluorescently labeled nucleotides. During template dependent primer extension, the incorporation of each successive nucleotide is observed by monitoring a characteristic fluorescent signal associated with such incorporation, allowing one to read the sequence of the extended primer, and by implication, the underlying, complementary template, as the polymerase synthesizes the nascent nucleic acid strand.

In order to obtain longer readlengths, a highly desirable criteria in nucleic acid sequencing, one needs to monitor the progress of the primer extension reaction over longer periods of time. As noted above, such constant illumination over long periods of time, particularly in the presence of oxygen, can lead to detrimental effects.

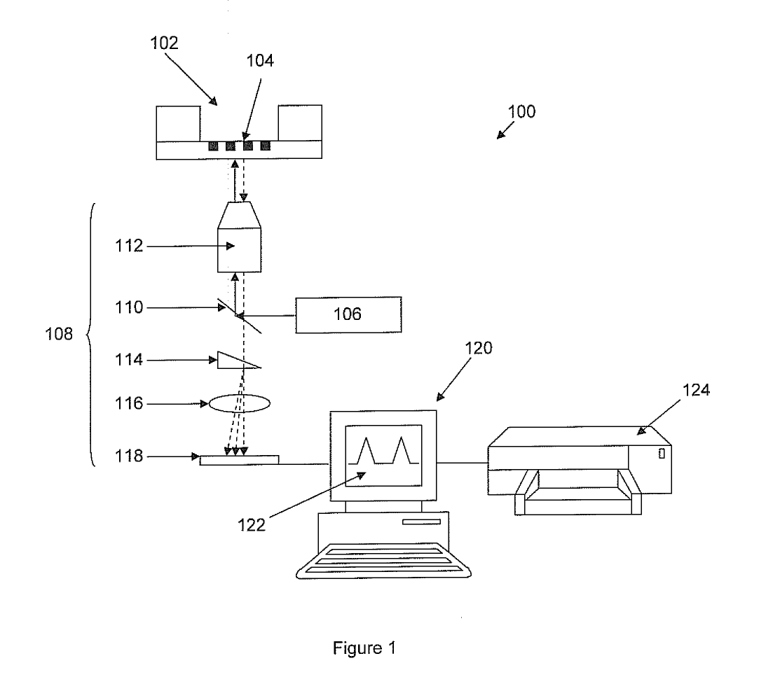

As will generally be appreciated, the real time fluorescent analysis systems of the invention, regardless of the type of reaction being monitored, will share a common general structure. A schematic illustration of such systems is shown in FIG. 1. As shown, the system 100 will generally include a reaction vessel 102, that may include one or more reaction regions within it, e.g., reaction region 104. The system also includes an excitation light source such as laser 106, and an optical train 108 that transmits excitation light from laser 106 to the reaction vessel 102. Light from excitation source 106 is typically directed to a dichroic mirror 110, which reflects the excitation light at a 90° angle through an objective lens 112, that focuses the excitation light onto the reaction region 104. Fluorescent signals from the reaction region 104 are collected by the objective lens 112 and, by virtue of having a different spectrum from the excitation light, are transmitted by dichroic 110, and focused by focusing lens 116 onto detector 118. Signals from detector 118 are then transmitted to an attached processor or computer 120, where they acre subjected to analysis, and/or display to the user in a convenient and understandable form, e.g., as a display 122 or printout 124. Optional spectral separation optics may also be provided within the optical train 108, including, for example, spectral filters or dispersive optical elements such as prism 114. Such spectral separation optics separate and separately direct spectrally different signal components to different locations on the detector 118, or to different detectors, to allow for separate detection of events that yield such spectrally distinct signals, e.g., resulting from reactions with differentially labeled nucleotides, or the like. As will be appreciated, alternative configurations may employ dichroics that reflect the fluorescent signals while transmitting the excitation light.

In addition to the foregoing components, the systems of the invention may employ other components that improve analysis, including, for example, multiplex optics, for generation of multiple discrete illumination beams, beam shaping optics, to generate beam spots of differing shapes, e.g., linear spots, elliptical spots and the like, confocal filters, to filter out of focus signal noise components, dispersive elements or spectral filters for separation of spectrally distinct signal components, and the like. A variety of these components are described in various combinations in, e.g., Published U.S. Patent Application Nos. 2007-0036511, 2007-095119, and 2007-0188750, the full disclosures of which are hereby incorporated herein by reference in their entirety for all purposes.

As will be appreciated, the reaction region 104 and reaction vessel 102 may take a variety of forms. For example, the reaction region may comprise one or more discrete locations on a substrate. For example, such reaction regions may comprise discrete patches of molecules that are used to interrogate samples for an ability to interact with such molecules. Most common examples of such substrates include molecular arrays upon which discrete patches of molecular binding groups, such as nucleic acids, antibodies, biochemical receptors, and the like, that are used to test whether components of a sample are capable of interacting with such molecules. Other reaction regions may include immobilized reaction components, such as enzymes or enzyme complexes, that may be employed to other ends. For example, arrays of immobilized complexes of nucleic acid polymerases and their associated template/primer sequences may be used to monitor the incorporation of nucleotides in a primer extension reaction, and through such monitoring, identify the underlying sequence of nucleotides in the template. Such complexes may be immobilized upon planar substrates, like conventional arrays, or they may be included within confining structures, in addition to the reactions vessels, e.g., structural and/or optically confining structures. Examples of optically confining structures include, for example, zero mode waveguides, as described in U.S. Pat. Nos. 6,917,726, 7,013,054, 7,181,122 and 7,292,742.

In preferred aspects, the systems of the invention are employed in conjunction with reaction regions that include individual molecules or molecular complexes that are optically resolvable from other molecules in the reaction vessel and/or adjacent reaction regions. In particular, and as noted above, the ability to protect molecular function against adverse effects, e.g., of photolytic or other effects, is of particular value in systems in which one is monitoring an individual molecule, and as such, any damage can end such monitoring.

In other aspects, the reaction regions may comprise regions of or discrete particle based solid supports, e.g., microbeads, nanocrystals, or the like, or it may comprise a surface of a reaction vessel or well within a multi-well reaction plate. A wide variety of particle based solid supports are known in the art, and include, e.g., commercially available biocompatible beads available from, e.g., Invitrogen, Inc. (Carlsbad, Calif.), Bangs Laboratories, Inc. (Fishers, Ind.), and the like.

### II. Reduced Oxygen Systems

As noted above, the present invention provides systems and methods of using such systems in the real-time analysis of fluorescent signals from reactions. In doing this, such systems preferably include one or more components that serve to reduce the level of oxygen that is present within the reaction mixture during the analysis, and as a result, reducing the level of any oxygen mediated instability of the various reaction components. In the context of the present invention, the oxygen reducing processes typically rely upon mechanical methods of oxygen reduction. Of course, this may be done in conjunction with other, non-mechanical methods. By mechanical methods of oxygen reduction is meant methods of oxygen reduction that do not involve chemical or enzymatic oxygen up-take or removal, and includes, for example, vacuum based systems, sparging or flushing methods, and the like. In contrast, the non-mechanical means typically employ such chemical and/or enzymatic oxygen scavengers.

Reduction of oxygen present in the reaction mixture is generally accomplished through one or more of: (1) reduction of oxygen being introduced into the system in the reagents themselves or the reaction mixture; (2) removal of oxygen present in the reaction mixture or its components; and (3) reduction of oxygen exposure of the reagents and or reaction mixtures that are being analyzed. Through one or more of these approaches, the aim of the system is to provide fluorescent or fluorogenic reaction mixtures in the reaction vessel, which are subjected to illuminated optical analysis, e.g., fluorescence excitation, in which the dissolved oxygen concentration is below 10 ppb, preferably below 5 ppb and even more preferably, below 1 ppb. Typically, oxygen sensors will have lower detection limits in the range of 10 ppb. As such, alternative strategies for determining oxygen concentrations may be employed, including the use of sensitive oxygen chemical sensors, such as the use of Cy5 dye, available from GE Healthcare, which demonstrates an oxygen dependent rate of photobleaching under excitation illumination, which sensitivity can be calibrated down to the ppb range.

As alluded to above, a first approach in reducing the amount of oxygen present in the reaction mixture and system is to avoid introducing oxygen in the first instance. In particular, reagents that are used in the systems of the invention are typically treated so as to avoid introducing oxygen, or to reduce or eliminate any oxygen present in such reagents, prior to placing them in the reaction vessel. In particular, reagents will typically be treated in advance to reduce dissolved oxygen levels below those concentrations set forth above. As a first order, such treatments may comprise simple treatments, such as basic degassing of the reagents, buffers and other reaction mixture components, prior to their use in the reaction systems of the invention. De-gassing will typically comprise placing the reagents under vacuum while concurrently agitating them, boiling them or the like, to ensure maximal removal of oxygen. Alternatively or additionally, the reagents may be subjected to oxygen scavenging systems or reagents, such as passing the reagents through oxygen scavenging columns or beds, e.g., enzymatic oxygen removal matrices, e.g., immobilized glucose oxidase/catalase matrices, iron particles or iron containing matrices, or the like.

Alternatively or additionally, fluidic systems may also be configured for the active or passive removal of oxygen from fluids disposed within them or that pass through them. For example, in some cases, fluidic subsystems of the systems of the invention may be outfitted with oxygen removal components for the in-situ removal of oxygen from various reaction components or the overall reaction mixture. For example, oxygen scrubbers may be coupled to the fluidic systems that are upstream of or include sealed reaction vessels, to allow for the removal of oxygen from fluid components of the reaction. Such oxygen systems typically operate by contacting the fluid reaction component with a gas permeable membrane across which is created a gradient in the oxygen partial pressure. This may be accomplished through the application of a vacuum to the side of the membrane opposite the reagent being treated, or by applying a sweeping gas, e.g., an inert gas such as nitrogen, argon, helium or the like, or both.

Because the membrane is gas and not liquid permeable, dissolved gas in the fluid is drawn through the membrane while the fluid components are retained within the fluidic channel or vessel. Gas permeable membranes useful in this application are generally commercially available from a variety of sources, e.g., Membrana, GmbH (Wuppertal, Germany).

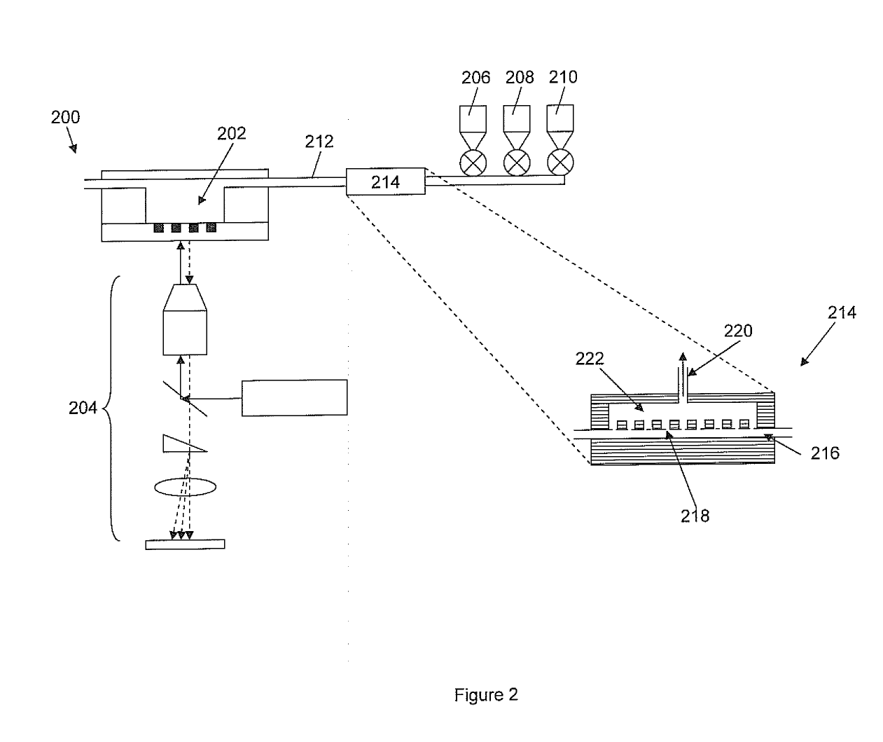

An illustration of a system 200 employing an oxygen scrubber is schematically illustrated in FIG. 2. As shown, a sealed reaction chamber 202 is provided that is optically accessible to fluorescence detection system 204. The sealed reaction chamber 202 is fluidically coupled to sources 206-210 of relevant reagents for the given analysis. For example, in the case of nucleic acid analyses using immobilized polymerase enzymes, e.g., as described above, the reagents may include labeled nucleotides or nucleotide analogs, target nucleic acid sequences, primers, buffers, salts (e.g., Mg⁺⁺ buffers, for initiation of polymerization), and the like. According to certain aspects, the fluid conduit 212 between the reagent sources 206-210 and sealed reaction chamber 202 will include an in-line oxygen scrubber 214. As noted above, the oxygen scrubber 214, shown in expanded detail, will typically include a fluid conduit 216 that is bounded in part by an oxygen permeable membrane 218 (shown as a dashed line). A non-oxygen environment is provided on the opposing side of the membrane 218. Such non-oxygen environment may be the result of a vacuum being pulled across the oxygen permeable membrane from vacuum line 220 and vacuum manifold 222. Alternatively, a non-oxygen sweeping gas, such as argon, nitrogen, helium, or the like may be provided adjacent the membrane 218, e.g., in manifold 222 via line 220, to reduce the partial pressure of oxygen in this region and promote oxygen transfer across membrane 218, and out of the reaction fluid.

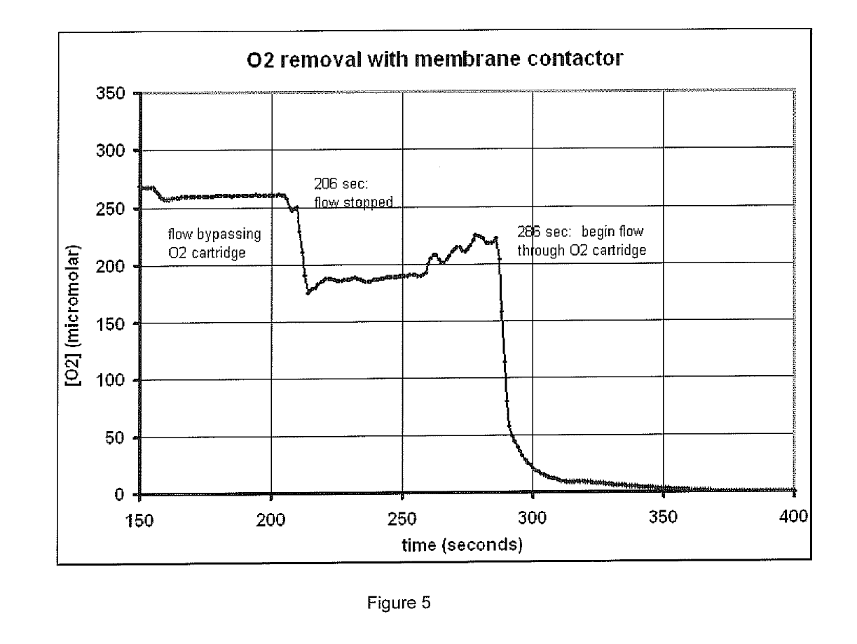

FIG. 5 shows the removal of O₂ from a flowing sample of deionized H₂O by a Membrana Micromodule cartridge. Water flowed through the labyrinth of semipermeable tubing within the cartridge which is surrounded by high purity argon “sweep gas” that is drawn off by a vacuum pump. The O₂ concentration of water emerging from the cartridge was detected using a fiber optic O₂ meter. At the beginning of the trace in FIG. 5 (t=150 seconds), water was flowing through a shunt that bypassed the cartridge, and a typical 09 concentration of 260 micromolar is observed. At 206 seconds, the flow of water was stopped, and the shunt removed, and the flow path was redirected through the O₂ removal cartridge. At 286 seconds, the flow was turned back on, and an immediate drop in O₂ concentration was observed. The rapid initial drop in [O₂] to below 10 micromolar was followed by a slower drop to below the detection limit of the meter of <500 nM. At 370 seconds, the indicated O₂ concentration dropped below zero, which is believed to have resulted from an artifact of the calibration of the meter.

Notably, the observed [O₂] in the water emerging from the cartridge was far lower than anything shown in the product literature for the cartridge, which is believed to result from the use of a sweeping gas with far lower partial pressure of O₂ than that typically used for the cartridge.

As can be seen, most of the drop in [O₂] takes place over the 1^{st} 5 seconds, after which there was a slower phase (between 300 and 370 seconds) that is likely due to the dead volume in the flow system mixing deoxygenated with oxygenated water downstream of the cartridge.

While use of applied vacuum and/or sweeping gases across oxygen permeable membranes provides a simple implementation of in-line oxygen reduction, it will be appreciated that oxygen scrubbers may be employed that provide flow-through reactive oxygen removal systems, e.g., immobilized oxygen removal agents, such as those described elsewhere herein, e.g., solid support immobilized GO-Cat enzyme systems retained within a flow-through column or housing, or other oxygen consuming reagents, e.g., iron powders, and the like.

In addition to de-gassing approaches, reagents will also typically be sparged with and or stored under an environment of inert, non-oxygen gas, such as argon, nitrogen, or the like, to further eliminate oxygen and prevent dissolution of further oxygen into the reagents. Other non-mechanical treatments comprise the addition of oxygen scavenging or removal agents to the reaction components. A variety of oxygen scavenging systems are known in the art, and include, e.g., enzymatic oxygen removal systems, e.g. glucose oxidase/catalase systems (GO-Cat), chemical oxygen removal systems (as described in published U.S. Patent Application No. 2007-0161,017, the full disclosure of which is incorporated herein by reference in its entirety for all purposes), and the like.

In addition to the dissolved oxygen within the reagents themselves, where sealed fluid delivery and/or reaction systems are not used, the process of introducing such reagents into reaction vessels can involve significant risk of oxygenating such reagents. This is particularly the case where the systems used in that fluid introduction include large automated systems, such as fluidic systems that include, e.g., manifolds, valves, pumps, pipetting systems, and plate handling systems. In accordance with the goals of the invention, such systems are also typically operated in a reduced oxygen or oxygen free environment. For example, in the case of fluidic systems, the fluid containing portions or conduits will typically be flushed with inert, non-oxygen gas, in order to reduce the presence of oxygen in such components. Flushing such components may be accomplished through a number of means, but is preferably carried out through the integration of such inert gas systems into the fluidic system, so that the system may be automatically flushed prior to reagent introduction. Included within the foregoing is the flushing of any non-integrated fluid handling systems. For example, in the case of pipetting systems used to deliver reagents to the reaction vessel or vessels to be used in the desired analysis, such systems will typically be flushed with inert non-oxygen gas prior to their use in accessing and dispensing reaction fluids. Such flushing systems may again be integrated within the pipette systems or may simply involve repeated intake and aspiration of inert, non-oxygen gas by the pipetting system in a non-oxygen environment, to effectively replace any oxygen present in such systems with inert gas.

In addition to removing oxygen form the fluids, conduits, and chambers of the overall system, maintaining a reduced oxygen environment may also rely upon fabrication of system components from oxygen impermeable materials, such as glass, metal or oxygen impermeable polymers, such as polymethylmethacrylate (PMMA), polyethylene terephthalate (PET), and polyvinylchloride (PVC), and the like. In some cases, oxygen scavenging polymers may be employed in the manufacture of at least some or portions of one or more of the various system components. Examples of such polymers include, e.g., oxygen scavenging PET (See, U.S. Pat. No. 6,544,611, which is incorporated herein by reference in its entirety for all purposes).

As alluded to above, many of the various system components will be configured or operated in a manner to minimize the exposure of the fluids of the system to oxygen environments. As noted, this is typically accomplished by one or more of maintaining the reactants in a reduced oxygen environment (that may include non-oxygen barrier gases, or application of low pressure or vacuum environments to the reactants), and/or use of oxygen scavenging or reducing treatments, as set out in greater detail elsewhere herein. With respect to the system shown in FIG. 2, it will be appreciated that a variety of system components, including e.g., reagent sources 206-210, fluid conduits 212, and reaction vessel 202, among other components, will be maintained under reduced oxygen environments.

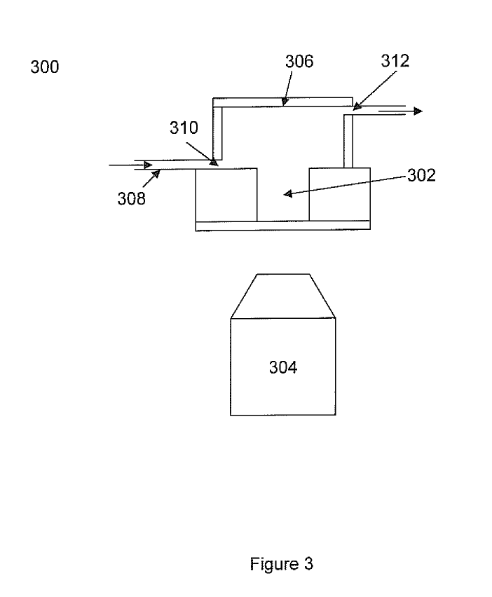

In addition to preventing or minimizing introduction of oxygen into the reaction mixture through the various added reagents, the systems of the invention also optionally minimize the dissolution of oxygen into the reaction mixture itself, by providing an oxygen reduced or oxygen free environment for the reaction mixture in the reaction vessel. This is typically accomplished by providing the reaction vessel within a reduced oxygen chamber both prior to and during the analysis. FIG. 3 schematically illustrates a system of the invention, including a reduced oxygen chamber. As shown, the system 300 includes the reaction vessel 302 positioned to be within optical communication with the optical detection system, as represented by objective lens 304, such as the optical detection system 100 shown in FIG. 1. As shown, a chamber 306 is positioned over reaction vessel 302. Chamber 306 is typically connected to a source of inert, non-oxygen gas, such as argon or nitrogen via a valved gas line 308, that provides such gas to the chamber via inlet 310. Outlet 312 typically permits excess gas to exit the reaction chamber. As will be appreciated, the configuration of the reaction chamber 306, the inlet 310 and outlet 312, may be varied to provide optimal circulation of gas to ensure substantial reduction or elimination of oxygen from the chamber 306. In terms of the chamber itself, baffles may be provided within the chamber to enhance distributed gas flow therein. Likewise, the inlet and outlet valves may be placed to provide optimal and filling of the chamber before excess gas passes from the outlet valve. For example, as shown, the inlet valve is illustrated as coming in at the lower part of the chamber while the outlet valve is shown at the upper part of the chamber. Such configuration would provide enhanced filling/evacuation in the case of gases that are heavier than oxygen. The inverse configuration would be particularly useful for gases that are lighter than oxygen.

Although chamber 306 is shown as being closed but for the gas inlet/outlet (310/312), it will be appreciated that the chamber 306 may be open, e.g., at the top as a chimney, to provide access to the reaction vessel, e.g., for the introduction of reagents via pipetting systems or other fluid handling methods, without having to dismantle the overall apparatus. In such cases, the gas may be delivered into the chimney where it can settle over the fluids in the reaction chamber and prevent oxygen contact and dissolution into such fluids, while reagents are introduced through the layer of inert gas. As will be appreciated, the reaction vessel 306 is configured so as not to obscure the ability to optically interrogate the reaction vessel. As such, the reaction vessel can be maintained under the reduced oxygen environment while concurrently being observed by the detection system as represented by objective 304. While this can be accomplished by providing observation windows within the chamber 306, as shown, the reaction chamber 306 is fitted over the top of the reaction vessel 302, e.g., as a chimney or cover on the reaction vessel, thus allowing observation through the bottom of the reaction vessel itself.

Although illustrated as individual reaction vessels included within the various sealed clambers, and the like, of the invention, it will be appreciated that the reaction vessels of the invention will typically be provided as arrays of reaction vessels. Thus, for example in the case of a sealed reaction chamber, a multi-reaction vessel array may be provided within a single sealed chamber. Typically, such reaction vessels will be provided in conventional formats that are readily interfaced with existing fluid handling and/or monitoring systems, e.g., in a 96, 384 or 1536 well format, where the vessels are disposed in rows and or columns on 9 mm, 4.5 mm or 2.25 mm centers.

In addition to preventing the passive introduction of oxygen into the reaction mixture by maintaining the reaction mixture in a reduced oxygen environment, prevention of oxygen introduction into that reaction mixture, in accordance with the present invention, also optionally includes the treatment or configuration of upstream system components to prevent inadvertent oxygen introduction into reaction fluids introduced through such system components. In particular, fluid handling systems that operate upstream of reaction systems often provide substantial opportunity for introduction of oxygen into reaction fluids through the creation of high surface area situations where oxygen will more freely dissolve into the reaction fluids, e.g., through agitation droplet or bubble formation or the like. Additionally, such systems may include components that inherently evolve oxygen or other gases into the fluids brought into contact with them.

Accordingly, in at least one aspect, the present invention provides for the maintenance of such upstream systems, such as fluid handling systems, e.g., pipetting robots or other pipetting systems, reagent storage systems, and the like, under a reduced oxygen environment. Such reduced oxygen environment may include vacuum treated components, but typically and preferably, includes such systems sparged or flushed with non-oxygen gas, such as helium, argon, nitrogen, or the like.

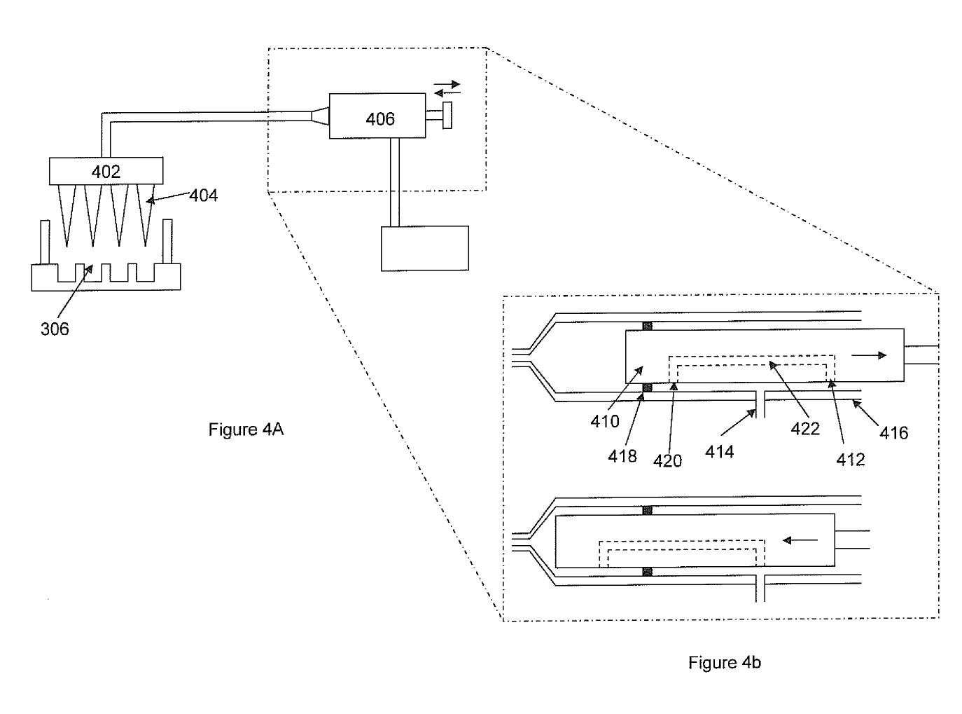

An example of a fluid handling system in accordance with the present invention is schematically illustrated in FIG. 4A in conjunction with the reaction vessel 306 of the system illustrated in FIG. 3. As shown, a pipette head 402 is provided within chamber 306 to permit introduction of reagents into the reaction vessel under the reduced oxygen environment. The pipette tips 404 in pipette head 402, are fluidly coupled to a pump such as positive displacement pump 406, that draws and expels in accordance with the desired volume of reagents to be delivered by the system. The pump 406 is configured to provide a purging flow of inert gas through the pipette tip 404, as illustrated further in the expanded view (FIG. 4B). In particular, piston 410 of pump 406, is configured to permit the flow of gas through its core and into pipette tip 404, when the piston is moved to expel fluid from the pipette tip, or otherwise as desired (lower image). As shown, when the piston 410 moves into the “expel” or “purge” position, gas inlet port 412 on the piston 410 is moved into communication with gas port 414 on the pump housing 416 above lower seal 418, while gas outlet port 420 is below lower seal 418. This allows flow of gas from gas port 414, through the gas inlet port 412 and gas conduit 422 in the piston 410 and into pipette tip 404. When the piston is moved back into the pump housing, e.g., when drawing reaction fluids, the gas outlet port 420 on the piston 410, is drawn up above the lower seal 418, thus stopping flow of gas to the pipette tip 404.

In addition to the foregoing, it will be appreciated that prior to use, the systems of the invention will optionally have all fluid conduits sparged with non-oxygen gas, to prevent incidental oxygen introduction into such fluids. Likewise, reaction storage vessels, will also typically be provided in low oxygen environments, e.g., by sparging such containers with non-oxygen gas and/or maintaining the fluids in these containers under a non-oxygen atmosphere.

Using the systems of the invention results is aimed at providing a substantial reduction in the level of dissolved oxygen present in the reaction mixture that is being analyzed over the level of oxygen that would be present under ambient conditions exposed to oxygen with no other mitigation efforts. By way of reference, concentration of oxygen in aqueous solutions exposed to ambient air typically falls around 250 μM or 10 ppm. Accordingly, the systems and methods of the invention are intended to reduce the level of dissolved oxygen to at or below detection limits of typical oxygen detectors, e.g., 250 nM or 10 ppb. In the absence of conventional detection methods for oxygen at such levels, the systems of the invention may be shown to provide such reduced oxygen levels through the use of oxygen sensitive chemicals, and monitoring their decay relative to the same chemicals at known oxygen levels that are within the detection limits of conventional detectors. One such chemical system monitors the oxygen dependent photobleaching of a fluorescent dye, Cy5 (available from GE Healthcare). In particular, the rate of photobleaching of Cy % is monitored relative to the rate of decay in a solution containing at 250 μM oxygen.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually and separately indicated to be incorporated by reference for all purposes.

What is claimed is:

1. An analytical system, comprising:
a reaction vessel containing a reaction mixture that comprises at least a first biochemical reactant and a first fluorescent or fluorogenic reactant;
an excitation light source configured to direct excitation light at the reaction vessel; and
a reagent delivery system fluidically coupled to the reaction vessel, wherein the fluid delivery system is configured to reduce dissolved oxygen present in reagents delivered to the reaction vessel.

2. The analytical system of claim 1, wherein the fluid delivery system comprises at least a first fluid conduit having an integrated oxygen scrubber.

3. The analytical system of claim 1, wherein the fluid delivery system comprises a pipette system, wherein the pipette system is configured to purge pipette tips with a non-oxygen gas.

4. An analytical system, comprising:
a reaction chamber;
a source of inert, non-oxygen gas coupled to the reaction chamber;
a reaction vessel disposed within the reaction chamber and containing a reaction mixture that comprises at least a first biochemical reactant and a first fluorescent or fluorogenic reactant, wherein the reaction mixture is capable of generating reactive oxygen species when exposed to excitation light; and
a fluorescence detection system configured to direct excitation light at the reaction vessel, and collect fluorescent signals from the reaction vessel.

5. The analytical system of claim 4, wherein the reaction chamber is sealed except for an inlet port coupling the reaction chamber to the source of inert, non-oxygen gas.

6. The analytical system of claim 4, wherein reaction chamber is open at an upper surface to provide access to the reaction mixture within the reaction vessel.

7. The analytical system of claim 4, wherein the inert, non-oxygen gas is selected from Argon and Nitrogen.

8. A method of monitoring a biological reaction, comprising:
providing a reduced oxygen reaction vessel;
introducing at least one reagent to the reduced oxygen reaction vessel to provide a biological reaction mixture that produces a fluorescent signal indicative of the biological reaction, wherein the at least one reagent is maintained in a reduced oxygen environment prior to introduction into the reduced oxygen reaction vessel; and
monitoring fluorescent signals from the reduced oxygen reaction vessel to monitor the biological reaction.

9. The method of claim 8, wherein maintaining the at least one reagent in a reduced oxygen environment comprises sparging with a non-oxygen inert gas one or more fluid handling systems used to introduce the at least one reagent into the reduced oxygen reaction vessel.

10. A method of monitoring a biological reaction, comprising:
providing a reduced oxygen reaction vessel;
introducing at least one reagent to the reduced oxygen reaction vessel to provide a biological reaction mixture that produces a fluorescent signal indicative of the biological reaction, wherein the at least one reagent is treated with an oxygen removal system prior to introduction into the reduced oxygen reaction vessel; and
monitoring fluorescent signals from the reduced oxygen reaction vessel to monitor the biological reaction.

11. The method of claim 10, wherein treating the reagent with an oxygen removal system comprises contacting the reagent with an oxygen scrubber.

12. The method of claim 11, wherein the oxygen scrubber is integrated into a fluid conduit, and the step of contacting the reagent with the oxygen scrubber comprises flowing the reagent through the fluid conduit.

13. A method of observing a reaction in real-time, comprising:
providing a reaction mixture that comprises a fluorescent or fluorogenic reactant that produces a signal characteristic of the reaction;
providing a reduced oxygen environment over the reaction mixture;
directing excitation light at the reaction mixture during the reaction; and
monitoring fluorescent signals characteristic of the reaction, from the reaction mixture, during the reaction.
